(19) United States
(12) Patent Application Publication
(10) Pub. No.: US 2010/0088189 A1
(43) Pub. Date: Apr. 8, 2010

(54) Processing A Sale Using A Redemption Code and Applications Thereof

(75) Inventors: Michael Steven Fischler, Frisco, TX (US); Allan David Fischler, Carrollton, TX (US); John Michael Wainwright, Little Elm, TX (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Journey Education Marketing, Inc., Dallas, TX (US)

(21) Appl. No.: 12/246,308

(22) Filed: Oct. 6, 2008

(51) Int. Cl. G06Q 30/00; G06Q 20/00; G06Q 50/00; G06F 17/00

(52) U.S. Cl. 705/23; 705/16; 235/375; 705/14.38

(57) ABSTRACT

Embodiments of the present invention process sales using a redemption code to enable customers to purchase a products. In a first embodiment, a method processes a sale. A plurality of redemption codes are issued. Each redemption code corresponds to a product identifier that identifies a product. A redemption code from the plurality of redemption codes is received from a customer sent via one or more networks. A product corresponding to the redemption code received from the customer is determined using a computer storage medium. Finally, the product is sent to the customer.

### BACKGROUND

1. Field of the Invention

This invention generally relates to processing sales.

2. Background Art

Some products are sold to particular markets at discounted prices. For example, computer hardware and software are sold at discounted prices to academic purchasers, including students and educators. In some cases, the computer products sold to the academic market are identical to full price commercial versions. To protect their margins, computer product vendors may ensure that these deeply discounted products are sold only to qualified students and educators such as faculty, staff, and educational institutions.

According to the National Association of College Stores 2008 College Store Industry Financial Report, college students spent approximately $9.8 billion in college bookstores in the United States and Canada. Of the $9.8 billion, approximately $1.3 billion was for computer products, including software and hardware. These products often carry low margins, and many college bookstores have inventory issues and space shortages. For these reasons, college bookstores typically stock very few, if any, software products. Many on-campus college bookstores do not stock any software products at all, and those that do typically stock only best-selling titles.

For the computer products that are stocked, students may purchase the products using qualified financial aid funds from a point of sale in the college bookstore. For the computer products that are not stocked, students may have to purchase the products via a website that does not accept financial aid funds.

Methods and systems are needed that enable students and educators to purchase computer products using financial aid funds while conserving space at retail stores, such as college bookstores.

### BRIEF SUMMARY

Embodiments of the present invention process sales using a redemption code to enable customers to purchase a products. In a first embodiment, a method processes a sale. A plurality of redemption codes are issued. Each redemption code corresponds to a product identifier that identifies a product. A redemption code from the plurality of redemption codes is received from a customer via one or more networks. A product corresponding to the redemption code received from the customer is determined using a computer storage medium. Finally, the product is sent to the customer.

In a second embodiment, a system processes a sale. The system includes a redemption code issuer module that issues a plurality of redemption codes. Each redemption code corresponds to a product identifier that identifies a product. The system also includes a fulfillment portal module that receives a redemption code from a customer, determines a product corresponding to the redemption code received from the customer, and initiate sending of the product to the customer.

In a third embodiment, a computer program product includes a tangible computer usable medium having control logic stored therein for causing a computer to process a sale. The control logic includes a first computer readable program code for causing the computer to issue a plurality of redemption codes. Each redemption code corresponds to a product identifier that identifies a product. A second computer readable program code causes the computer to receive a redemption code from the plurality of redemption codes from a customer sent via one or more networks. A third computer readable program code causes the computer to receive a redemption code from the plurality of redemption codes from a customer sent via one or more networks. A fourth computer readable program code causes the computer to initiate sending of the product to the customer.

In a fourth embodiment, a system processes a sale. The system includes a merchandise display. The system also includes a merchandise tag adapted to be displayed on the merchandise display. The merchandise tag identifies a product with a product identifier. A point of sale maps the product identifier to a redemption code. Finally, a fulfillment portal module processes an order using the redemption code to ship the product to a customer.

Further embodiments, features, and advantages of the present invention, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and to use the invention.

FIG. 1 is a diagram illustrating processing a sale according to an embodiment of the present invention.

FIG. 2 is a diagram illustrating a system for processing a sale according to an embodiment of the present invention.

FIG. 3 is a flowchart illustrating a method for processing a sale according to an embodiment of the present invention.

FIGS. 4A-F are diagrams illustrating a user interface for completing a sale which may be used by a component of the system in FIG. 2.

FIG. 5 is a block diagram of an exemplary computer system useful for implementing embodiments of the present invention.

The present invention is described with reference to the accompanying drawings. The drawing in which an element first appears is typically indicated by the leftmost digit or digits in the corresponding reference number.

### DETAILED DESCRIPTION

Embodiments of the present invention process sales using a redemption code to enable students and educators to purchase computer products using financial aid funds. In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

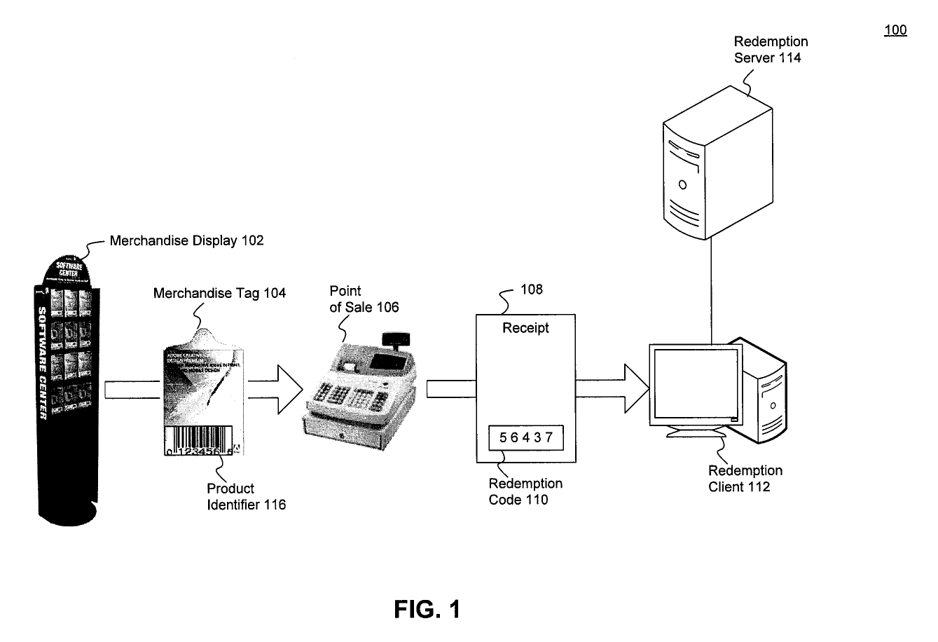

FIG. 1 shows a diagram 100 illustrating making a purchase according to an embodiment of the present invention. A retail store, such as a college bookstore, may have a merchandise display 102. Merchandise display 102 may be, for example, a peg-hook display having dimensions of approximately 66.5×16.75×6.25 inches. Merchandise display 102 displays merchandise tags, such as a merchandise tag 104. Each merchandise tag may represent an academically priced product. Each merchandise tag has a product identifier that identifies a product. Each merchandise tag may be a hang tag hanging on the peg-hook display.

In examples, academically priced products may include computer products, such as hardware and software including computer aided design (CAD) and engineering tools, animation and graphic design tools and video editing tools. Products may include shrink wrapped or fully packaged product, or an academically priced student license product (e.g. a student contractual licensing program). These examples are illustrative and are not meant to limit the present invention. Each merchandise tag may resemble the fully packaged product and may display information about the product, such as system requirements and a web address and phone number to go for additional details. Each merchandise tag may identify a product using a product identifier, such as product identifier 116. By displaying products as hang tags, the retail store does not have to keep the products in stock. This saves valuable floor space and reduces the need for the retail store to manage the additional inventory.

In an embodiment, product identifier 116 identifies a product associated with merchandise tag 104. Product identifier 116 may be a product stock keeping unit (SKU).

One type of SKU is a uniform product code. In an alternative embodiment, product identifier 116 may identify a particular item. One coding system that may identify particular items is the electronic product code (EPC) system. A product identifier may be encoded in a barcode as shown with product identifier 116 in diagram 100. Alternatively, a product identifier may be written in plain characters or encoded in a radio frequency ID tag. These examples are merely illustrative and are not meant to limit the present invention.

To purchase the product, a customer may take merchandise tag 104 to a point of sale 106. Point of sale 106 may deduct funds from the customer's financial aid account to make the purchase. When the purchase is made, point of sale 106 looks up a redemption code 110. Point of sale 106 may have a table mapping each product identifier to a redemption code. In the example illustrated in diagram 100, redemption code 110 (“56437”) is associated with product identifier 116 (“123456”).

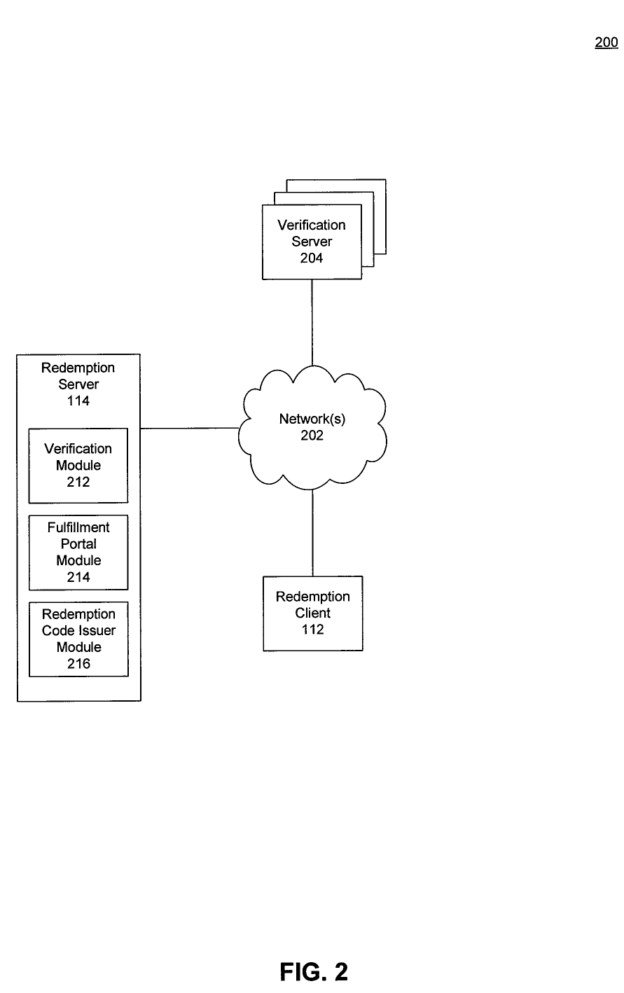

Point of sale 106 may print redemption code 110 on a receipt 108 which is provided to the customer. The customer enters redemption code 110 and other order information at a redemption client 112. Redemption client 112 coordinates with redemption server 114 to complete the order and ship the product to the customer. Prior to shipping the product, redemption server 114 may verify the enrollment status of the customer. Redemption client 112 and redemption server 114 are described in greater detail with respect to FIG. 2.

In this way, the customer is able to purchase a product, such as an academically priced software product, using financial aid, without the retail store having it stock the item. The retail store may be a bookstore, such an on-campus college bookstore.

FIG. 2 is a diagram illustrating a system 200 for processing a sale according to an embodiment of the present invention. System 200 includes redemption server 114 coupled to redemption client 112 via one or more networks 202, such as the Internet.

Redemption server 114 includes a fulfillment portal module 214 that enables a user to enter a redemption code to complete an order. In one example, redemption server 114 may include a web server and fulfillment portal module 214 may be an application running within the web server.

A web server is a software component that responds to a hypertext transfer protocol (HTTP) request with an HTTP response. As illustrative examples, the web server may be, without limitation, an APACHE HTTP Server, APACHE Tomcat server, MICROSOFT Internet Information Server, JBOSS Application Server, WEBLOGIC Application Server, or SUN Java System Web Server. The web server may contain web applications which generate content in response to an HTTP request. The web server may package the generated content and serve the content to a client in the form of an HTTP response. Such content may include hypertext markup language (HTML), extendable markup language (XML), documents, videos, images, multimedia features, or any combination thereof. This example is strictly illustrative and does not limit the present invention.

As mentioned earlier, a user may enter a redemption code into client 112. In response, client 112 may send the redemption code to redemption server 114.

Redemption client 112 may have, for example, a web browser. The web browser may receive a form, such as an HTML form, from fulfillment portal module 214 of redemption server 114. A user may enter the redemption code into the form and press a submit button. In response, the browser may send the redemption code to redemption server 114. The browser may send the redemption code to redemption server 114 as an HTTP parameter in an HTTP request.

A customer may complete other forms received from fulfillment portal module 214. For example, the user may complete forms collecting shipping information and verification information.

As mentioned earlier, often computer products may be specially priced for academic customers. The academic price may be substantially lower than the price for the general public. To protect margins, software manufactures and sellers must be wary to ensure that non-academic customers are not getting the academic price. Selling software over the Internet as opposed to from an on-campus may make the academically priced software more widely available. This wider availability may further increase the risk that a customer may misrepresent his/her academic status for a favorable price. To mitigate this risk, verification module 212 verifies that a customer is an academic customer such as a student or educator.

Verification module 212 may coordinate with one or more verification servers 204 to verify that the customer is a student or educator. Verification servers 204 may include servers that query enrollment databases such as the NATIONAL STUDENT CLEARINGHOUSE database and ECOLLEGE database. Verification module 212 may communicate with verification servers 204 using, for example, XML over an HTTP/HTTPS or secure sockets layer connection. These examples are merely illustrative. Verification module 212 may send identification or authentication information to verification servers 204, and verification servers 204 may respond with either confirming or denying the customer's enrollment status. Identification and authentication information may include, for example, the customer's login information (e.g. username and password), the customer's name, social security number, driver's license number, and birth date.

In another embodiment, verification module 212 may redirect the customer to another site for authentication. For example, verification module 212 may redirect a user to a single sign on site, such as the Yale Central Authentication Service or a school's extranet portal, to log in. After logging in, the customer may be redirected back to redemption server 114. When client 112 is redirected back to redemption server 114, client 112 may have an authentication token, such as a transaction ID, stored as a cookie or session variable. Verification module 212 may go through a final authentication step to verify the authenticity of the authentication token, for example, by making sending an XML request to an verification server 204.

In an alternative embodiment, verification module 212 may enable an operator to manually verify the student's enrollment by receiving verification documents such as a copy of a student ID or other authenticating document and reviewing it for authenticity. A customer may transmit verification documents via mail, fax, email, or via a web interface. These examples are merely illustrative and are not meant to limit the present invention.

As mentioned earlier, point of sale 106 in FIG. 1 may have a table that maps each product identifier to a redemption code. The table may be determined by a redemption code issuer module 216. Redemption code issuer module 216 may determine the redemption codes for each product identifier and send that information to point of sale 106. In an example, redemption code issuer module 216 may send the information to point of sale 106 electronically via an XML transmission. In another example, redemption code issuer module 216 may write the table to a computer memory, such as a computer disk, and an operator may install the codes at point of sale 106.

Each of redemption server 114, verification server 204, and redemption client 112 may be implemented in any computing device able to communicate over a network. The computing device may include at least one processor, a main memory, preferably random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit represents a floppy disk, magnetic tape, optical disk, etc. which is read by and written to by the removable storage drive. As will be appreciated, the main memory and the secondary memory may include a computer usable storage medium having stored therein computer software and/or data. The computer software may include an operating system and processes that may be run by a processor. The computing device may include a network interface coupled to network(s) 202.

Network 202 may be any network or combination of networks that can carry data communication. Such network 202 can include, but is not limited to, a local area network, medium area network, and/or wide area network such as the Internet. Network 120 can support protocols and technology including, but not limited to, World Wide Web protocols and/or services. Intermediate web servers, gateways, or other servers may be provided between components of system 200 depending upon a particular application or environment.

Each of verification module 212, fulfillment portal module 214, and redemption code issuer module 216 may be implemented in hardware, software, firmware or any combination thereof.

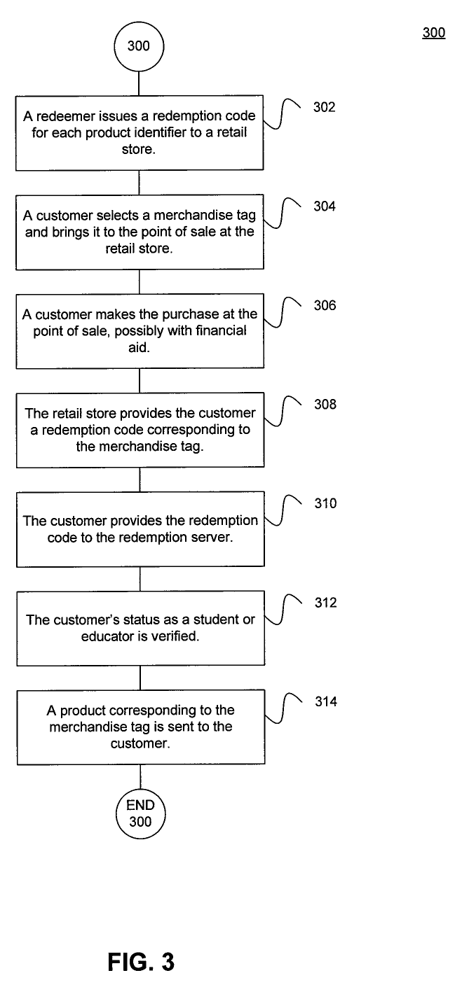

The operation of system 200 is described in greater detail with respect to FIG. 3.

FIG. 3 is a flowchart illustrating a method 300 for processing a sale according to an embodiment of the present invention. Method 300 begins at step 302.

At step 302, a redemption code is issued for each a product identifier. As mentioned earlier, the product identifier identifies a product and may be printed on a merchandise tag on a merchandise display. The redemption codes may be determined by a redemption server. In an embodiment, the redemption codes may include an identifier that corresponds to the product identifier and thus the product. In an example, the redemption code may be a coupon code. The redemption codes may be delivered to a retail store, and the retail store may install the redemption codes into a point of sale.

At step 304, a customer selects a merchandise tag from a merchandise display in a retail store. As mentioned earlier, the merchandise tag may display information about a product and has a product identifier to identify a product. The customer may carry the merchandise tag to a point of sale to make a purchase at step 306.

At step 306, a customer makes a purchase at the point of sale. The point of sale may deduct funds from the customer's financial aid account to process the sale. Many students have financial aid accounts funded with educational grants and loans. Students may be able to use some or all of those educational grants and loans on products such as computer products including hardware and software. The point of sale may recognize the portion of the financial aid that is available for purchases of computer products and may deduct up to that amount for the sale. The customer may pay for the remainder of the balance by conventional means, e.g., cash, check, credit card, etc. Alternatively, the customer may elect not to use financial aid funds and make payment using those conventional means. When the customer has made a payment, the retail store provides the customer with a receipt at step 308.

At step 308, the retail store provides the customer with a receipt including a redemption code. As mentioned earlier, the redemption code corresponds to the product identifier as determined in step 302. The point of sale, for example, may receive a product identifier by, for example, receiving a SKU from a barcode reader. The point of sale may look up a redemption code from the table determined in step 302. The redemption code may be, for example, a coupon code. The coupon code may be printed on the receipt provided to the customer. The receipt may also include instructions on how to complete the order including a web address of the redemption server. The retail store may attach the receipt to the merchandise tag and give both to the customer.

Following the instructions on the receipt, the customer may provide the redemption code to a redemption server at step 310. At step 310, the customer may go to a redemption client such as a computing device including a web browser. The customer may direct the web browser to the redemption server using the address printed on the receipt. A fulfillment portal on the redemption server may send the customer at least one form to complete the order. To complete the order, the customer may provide information to complete the order, including a shipping address. When prompted for a mode of payment, the customer may enter the redemption code printed on the receipt. Based on the redemption code, the redemption server determines the product purchased. The redemption server may set the price of the product to zero, as the customer has already paid for the product at the point of sale in the retail store.

In addition to shipping and payment information, the fulfillment portal may request that the customer input information to verify that the customer is a student or educator. The verification information may include login information, a social security number, a birth date, etc. With the verification information, the redemption server may verify that the customer is a student or educator at step 312. The redemption server may communicate with a verification server to determine whether the customer is a student. Alternatively, the fulfillment portal may accept scanned copies of a student ID or other verification documents, or the customer may transmit the copies separately via email, fax, or mail.

Once the redemption server has received the shipping and payment information and the customer's academic status has been verified, the fulfillment portal module initiated the sending of the product. For instance, a signal may be sent to initiate transfer of the product to a shipper along with instructions so that the product is shipped to the customer at step 314. The product may be shipped to the customer as a shrink wrapped product. Alternatively, the redemption server may enable a user to download a computer product. The redeemer, as opposed to the retail store, may handle any further customer service obligations including returns.

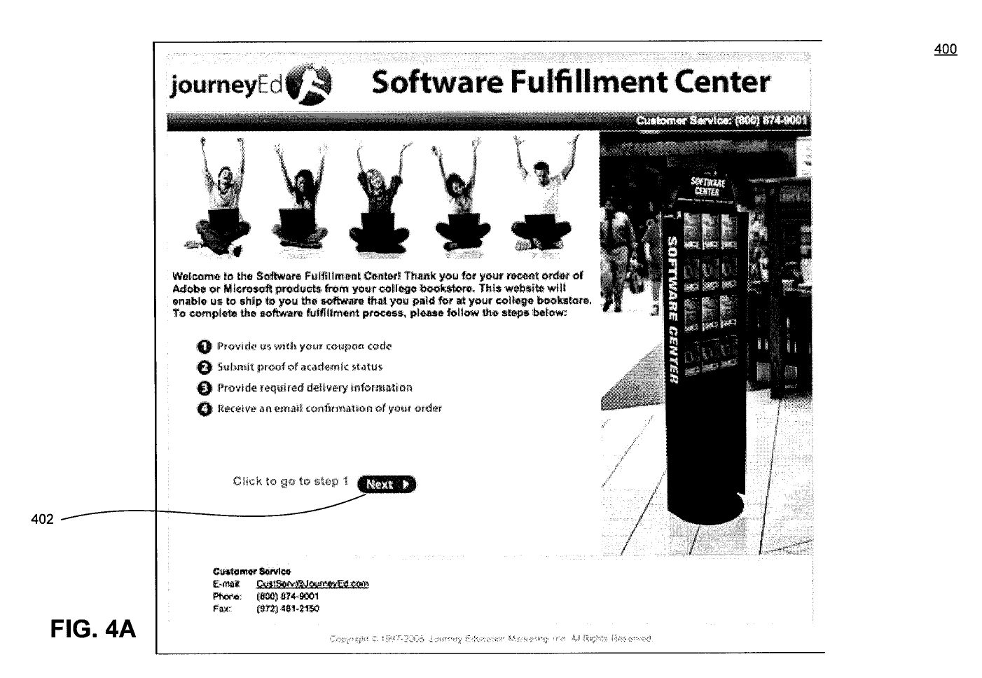

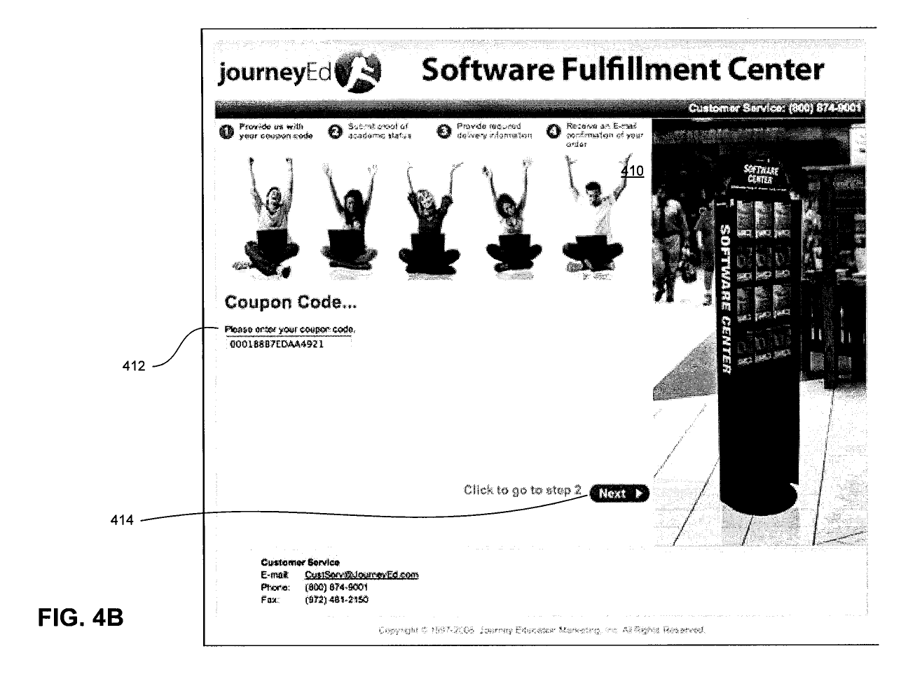

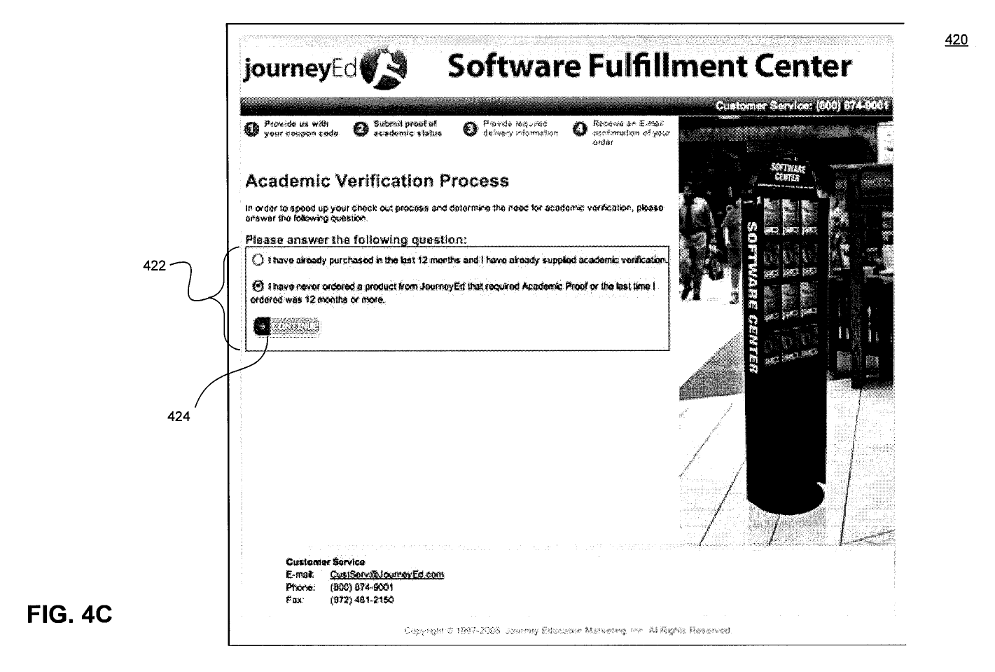

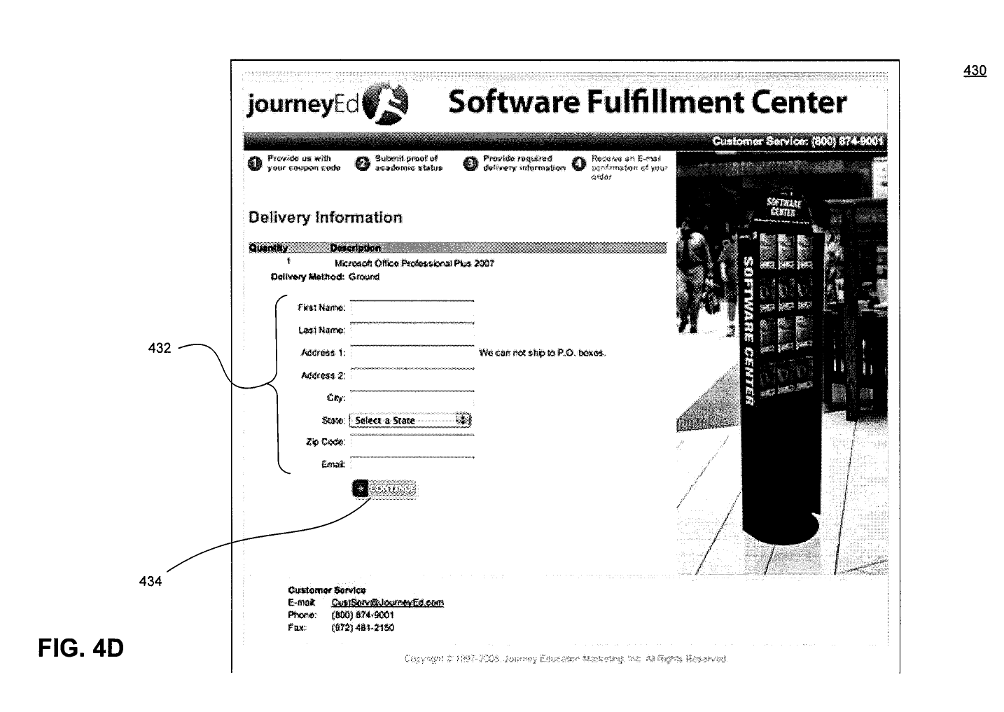

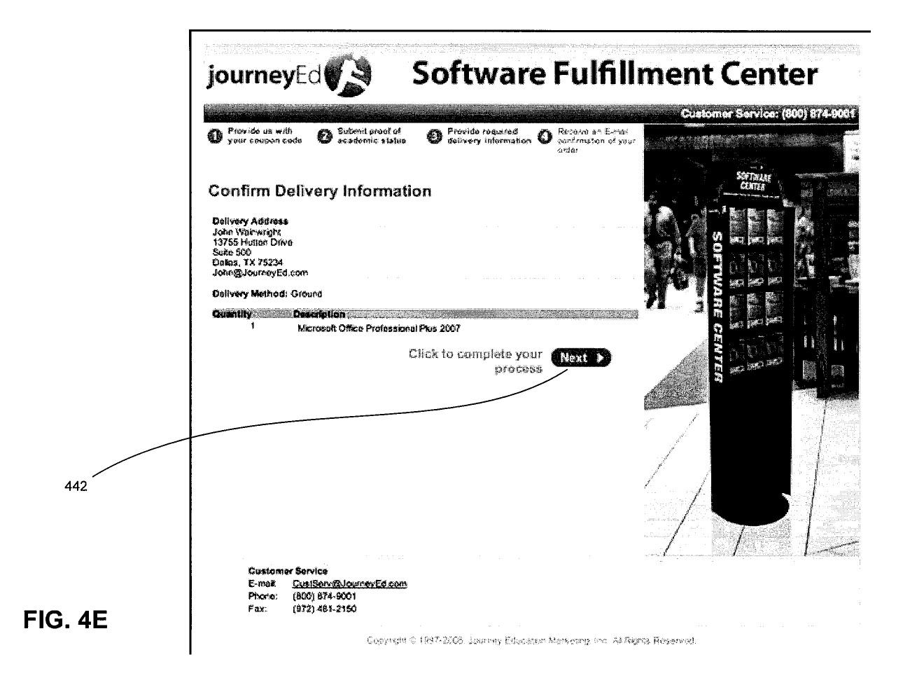

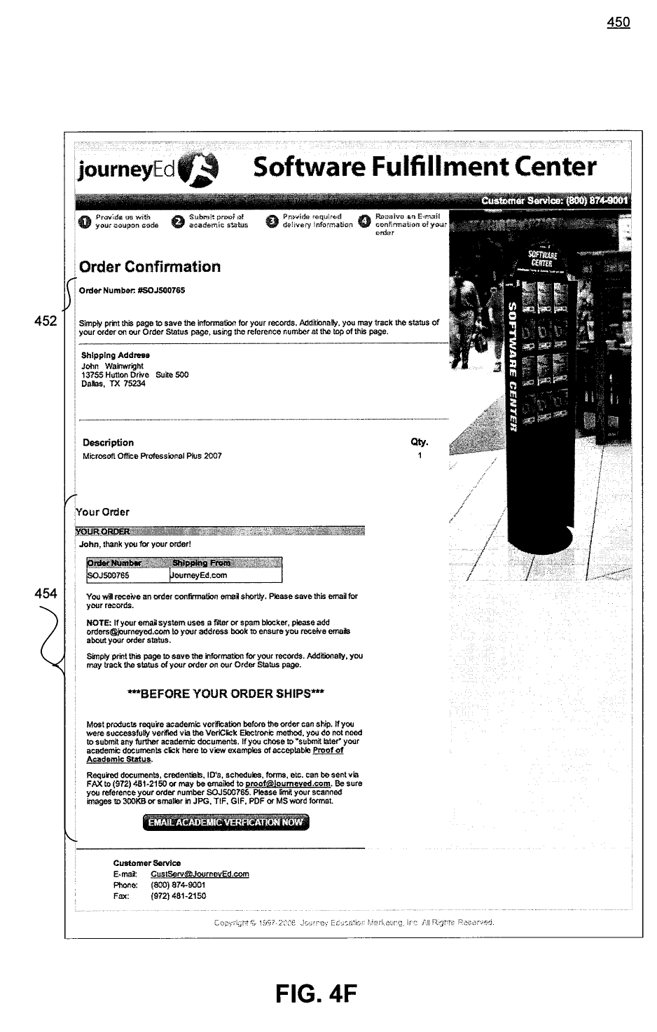

FIGS. 4A-F are diagrams illustrating a user interface for completing a sale which may be used by fulfillment portal module 214 in FIG. 2. When a customer enters the web address on the receipt, the customer may be directed to a user interface as illustrated in diagram 400 in FIG. 4. The user interface in screenshot 400 may include a button 402 that when pressed starts the fulfillment process.

When the customer selects button 402, the client may be redirected to a form illustrated in screenshot 410 in FIG. 4B. The form has a field 412 that prompts the customer for their redemption code. As mentioned, the redemption code may be printed on a receipt given to the customer at the point of sale. As mentioned earlier, the redemption code identifies a product. Once the customer enters the redemption code in field 412 and presses next button 414, the fulfillment portal may direct a user to a new interface as in FIG. 4C.

FIG. 4C shows a screenshot 420 that enables a user to verify his/her enrollment status. If the item being ordered is an academically licensed product, the customer may be required to verify his our her enrollment status. As discussed earlier, the enrollment status may be verified electronically by, for example, communicating with one or more verification servers. Alternatively, the customer can submit verification documents. If the customer has already verified their enrollment status within a particular time period, for example, 12 months, the customer may not have to go through the verification process again. This is illustrated by a form 422 that asks the customer whether his/her enrollment status has been verified in the past 12 months. The redemption server may, for example, store the customer's verification information or enrollment status. The user may select a button 424 to continue the verification process and navigate to an interface as in FIG. 4D.

FIG. 4D shows a screenshot 430. Screenshot 430 shows a form 432 that prompts the customer for shipping information. When the customer enters the shipping information, including name, address, etc, the customer may select a button 434 to submit the information. Upon submitting the shipping information, the customer has be redirected to an interface as shown in FIG. 4E.

FIG. 4E shows a screenshot 440 confirming the users order information. Screenshot 440 may display the customer's shipping information, the product ordered, and (optionally) the customer's verification information. If any of the information is inaccurate, the user may go back to previous interfaces and correct the information. If the information is accurate, the customer may select a button 442 that finalizes the order and navigates the user to an interface illustrated by a screenshot 450 in FIG. 4F. Screenshot 450 provides an order number 452. Order number 452 may be a reference number that the customer may use for inquiries related to the order. If the product is an academically licensed product and the customer was unwilling or unable to verify their academic status online during the fulfillment process, instructions may be provided in a frame 454 to provide verification documents.

By using a fulfillment portal to complete a sale made at a retail store, the customer is able to purchase a product using financial aid, without the retail store having it stock the item.

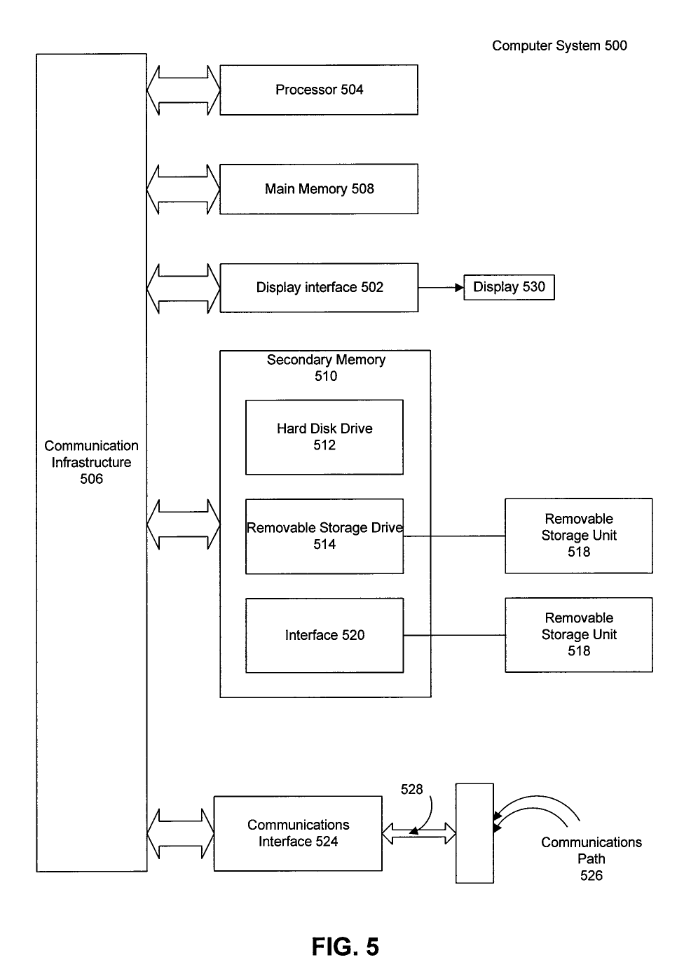

FIG. 5 is a block diagram of an exemplary computer system 500 useful for implementing embodiments of the present invention. In examples, redemption server 114, redemption client 112, verification server 204, or point of sale 106 may be implemented on exemplary computer system 500.

Computer system 500 includes one or more processors, such as a processor 504. Processor 504 is connected to a communication infrastructure 506 (e.g., a communications bus, cross over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from a communication infrastructure 506 (or from a frame buffer not shown) for display on a display unit 530.

Computer system 500 also includes a main memory 508, preferably random access memory (RAM), and may also include a secondary memory 510. Secondary memory 510 may include, for example, a hard disk drive 512 and/or a removable storage drive 514, representing a floppy disk drive, a magnetic tape drive, an optical disk drive, etc. Removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 518 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 518 and interfaces 520, which allow software and data to be transferred from the removable storage unit 518 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514 and a hard disk installed in hard disk drive 512. These computer program products provide software to computer system 500. Embodiments of the invention include such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable processor 504 to perform the features of the present invention. Accordingly, such computer programs represent controllers of computer system 500.

In an embodiment where the invention is implemented using software, the software may be stored in a computer program product and loaded into computer system 500 using removable storage drive 514, hard drive 512 or communications interface 524. The control logic (software), when executed by processor 504, causes processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for processing a sale, comprising:
(a) issuing a plurality of redemption codes, wherein each redemption code corresponds to a product identifier that identifies a product;
(b) receiving a redemption code from the plurality of redemption codes from a customer sent via one or more networks;
(c) determining a product corresponding to the redemption code received from the customer using a computer storage medium; and
(d) sending the product to the customer.

2. The method of claim 1, further comprising:
(e) verifying that the customer is a student or educator.

3. The method of claim 2, wherein the verifying (e) comprises communicating with a web service.

4. The method of claim 1, wherein the issuing (a) comprises providing the plurality of redemption codes to a point of sale.

5. The method of claim 4, wherein the issuing (a) further comprises providing the plurality of redemption codes to a point of sale, wherein the point of sale deducts from a financial aid account of the customer.

6. The method of claim 4, wherein the providing comprises providing the plurality of redemption codes, wherein each redemption code in the plurality of redemption codes corresponds to a product identifier on a merchandise tag.

7. The method of claim 1, wherein the receiving (b) comprises receiving the redemption code via a web interface.

8. A system for processing a sale, comprising:
a redemption code issuer module that issues a plurality of redemption codes, wherein each redemption code corresponds to a product identifier that identifies a product; and
a fulfillment portal module that receives a redemption code from the plurality of redemption codes from a customer, determines a product corresponding to the redemption code received from the customer, and initiates sending of the product to the customer.

9. The system of claim 8, further comprising:
a verification module that verifies that the customer is a student or educator.

10. The system of claim 9, wherein the verification module communicates with a web service to verify that the customer is a student or educator.

11. The system of claim 8, wherein the redemption code issuer module provides the plurality of redemption codes to a point of sale.

12. The system of claim 8, wherein the redemption code issuer module enables a user to provide the plurality of redemption codes to a point of sale.

13. The system of claim 11, wherein the point of sale deducts from a financial aid account of the customer.

14. The system of claim 11, wherein each redemption code in the plurality of redemption codes corresponds to a product identifier on a merchandise tag.

15. The system of claim 8, wherein the fulfillment portal module receives the redemption code via a web interface.

16. The system of claim 8, further comprising:
a processor; and
a memory coupled to the processor having the fulfillment portal module and the redemption code issuer stored thereon.

17. A computer program product comprising a tangible computer usable medium having control logic stored therein for causing a computer to process a sale, said control logic comprising, comprising:
a first computer readable program code for causing the computer to issue a plurality of redemption codes, wherein each redemption code corresponds to a product identifier that identifies a product;
a second computer readable program code for causing the computer to receive a redemption code from the plurality of redemption codes from a customer sent via one or more networks;
a third computer readable program code for causing the computer to receive a redemption code from the plurality of redemption codes from a customer sent via one or more networks; and
a fourth computer readable program code for causing the computer to initiate sending of the product to the customer.

18. The computer program product of claim 17, further comprising:
a fifth computer readable program code for causing the computer to verify that the customer is a student or educator.

19. The computer program product of claim 17, wherein each redemption code in the plurality of redemption codes corresponds to a product identifier on a merchandise tag.

20. The computer program product of claim 17, fifth computer readable program code for receiving the redemption code via a web interface.

21. A system for processing a sale, comprising:
a merchandise display;
a merchandise tag adapted to be displayed on the merchandise display, wherein the merchandise tag identifies a product with a product identifier;
a point of sale that maps the product identifier to a redemption code; and
a fulfillment portal module that processes an order using the redemption code to ship the product to a customer.

22. The system of claim 21, wherein the merchandise display is a peg board display and the merchandise tag is a hang tag adapted to hang on the peg board display.

23. The system of claim 21, further comprising:
a verification module that verifies that the customer is a student or educator.

24. The system of claim 21, wherein the product is an academically priced computer product.
